(19) United States
(12) Patent Application Publication
(10) Pub. No.: US 2011/0114620 A1
(43) Pub. Date: May 19, 2011

(54) COOKING APPLIANCE

(76) Inventors: Diane Lommel, Rothenburg (DE); Roberto Giordano, Pozzuolo Del Friuli (IT); Britta Burlin, Cuasso Al Monte (IT); Arran Allsebrook, Pordenone (GB); Kersten Kaiser, Rothenburg ob der Tauber (DE)

(21) Appl. No.: 12/440,523

(22) PCT Filed: Sep. 12, 2007
(86) PCT No.: PCT/EP2007/007939

§ 371 Date: Nov. 22, 2010

(30) Foreign Application Priority Data
Sep. 27, 2006 (EP) 06020205.8

(51) Int. Cl. H05B 1/00

(52) U.S. Cl. 219/209

(57) ABSTRACT

The invention relates to a cooking appliance (1) with a hob (2) and/or a cooking cavity (3) and a user interface (4) for inputting and/or displaying information for controlling a cooking process in the cooking appliance (1). To facilitate the handling of the cooking appliance, the invention is characterized in that the user interface (4) is detachably arranged at the cooking appliance (1).

The invention relates to a cooking appliance, with a hob and/or a cooking cavity and a user interface for inputting and/or displaying information for controlling a cooking process in the cooking appliance.

to Cooking appliances of this kind are well known in the art. Hobs and cooking cavities are usually operated by a user interface which is attached on the appliance, i. e. the user interface is firmly connected with the cooking appliance. Depending on the software of the user interface it can be very time consuming and is inconvenient to find the right setting for the cooking appliance when cooking a special recipe.

The possibilities of controlling the cooking appliance by the user interface are limited due to the fact that there are limitations with respect to data inputting and displaying. For example it is normally not possible to turn the hob down from a high heat setting to a low one without scaling down through all the intermediate settings.

Consequently, the possibilities are limited for displaying information, e. g. about the cooking process taking place. Also for cooking appliances it can be difficult to find the best settings for a special recipe in an easy way. The user interface, i. e. the controlling terminal in the appliance does not contain many information for recipe related information and the user manual often does not contain the needed information either. In spite of the fact, that memory space became cheap it is hard to display sufficient information with existing user interfaces.

If bigger. displays would be employed a respective space would be required which would make the hob or the cooking cavity smaller as the appliance has normally to keep a definite norm size.

Therefore, it is an object of the present invention to propose a cooking appliance of the above kind which overcomes the mentioned disadvantages. It should become possible to design the user interface sufficiently big to input data in a more convenient way and to display more information. Furthermore, the handling of data inputting should become more easy and convenient. In spite of this the (norm) dimensions of the cooking appliance have to be kept.

The solution of this object according to the invention is characterized in that the user interface an external or independent unit with regard to the cooking appliance or arranged outside of the cooking appliance and/or that the user interface is detachably arranged or fastened at the cooking appliance.

The cooking appliance can furthermore have at least one control system for controlling the cooking process in the cooking appliance. The at least one control system can be firmly connected with the hob and/or the cooking cavity or a part, especially a frame, carrying the same.

The user interface can be constructed as a unit having at least on inputting device and at least one displaying device.

The user interface can be in data connection with the cooking appliance, especially with the at least one control system, by means of a wire. Alternatively, it is possible that the user interface is in data connection with the cooking appliance, especially with the at least one control system, in a wireless manner. In the latter case the wireless connection can be for example a radio connection or a blue-tooth connection.

The inputting device can be a keyboard or a keypad. The displaying device can be a screen, especially a touch-screen.

Furthermore, the user interface can have a memory device for recording data for controlling a cooking process in the cooking appliance. A preferred embodiment is characterized in that the memory device is arranged for receiving cooking recipe data for a plurality of recipes. The cooking recipe data can include related cooking parameters.

Furthermore, the memory device can be arranged for receiving data of an electronic handbook. Consequently, it becomes redundant to keep a handbook for the cooking appliance at all.

Finally, a preferred embodiment of the invention is characterized in that the user interface is a laptop.

By using the invention it becomes possible to direct setting data for controlling the cooking appliance. The handling becomes quite easy, without a slow reacting user interface on the appliance.

The user interface can be constructed sufficiently big without taking space from the hob cooking area or from the cooking cavity.

Due to the improved handling it becomes possible to faster set changes in the cooking program without scrolling through long menus; this is the result of using significant bigger displays where more information can be displayed simultaneously.

When stored information in the user interface is used it becomes possible to use receipe related search functions for best setting of cooking parameters. Also, an electronic user manual can be stored.

Consequently, better cooking results can be obtained because the right parameters (temperatures and heating modes) can always be used.

In the drawings an embodiment of the invention is depicted.

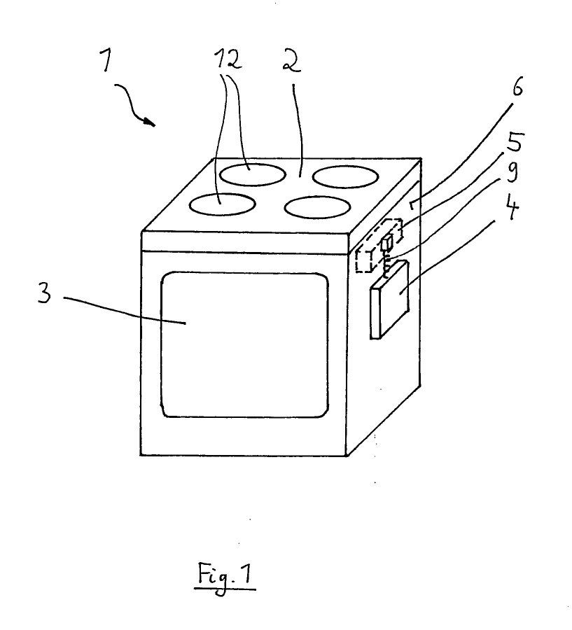

FIG. 1 shows a domestic cooking appliance in a perspective view, when the user interface of the cooking appliance is not used,

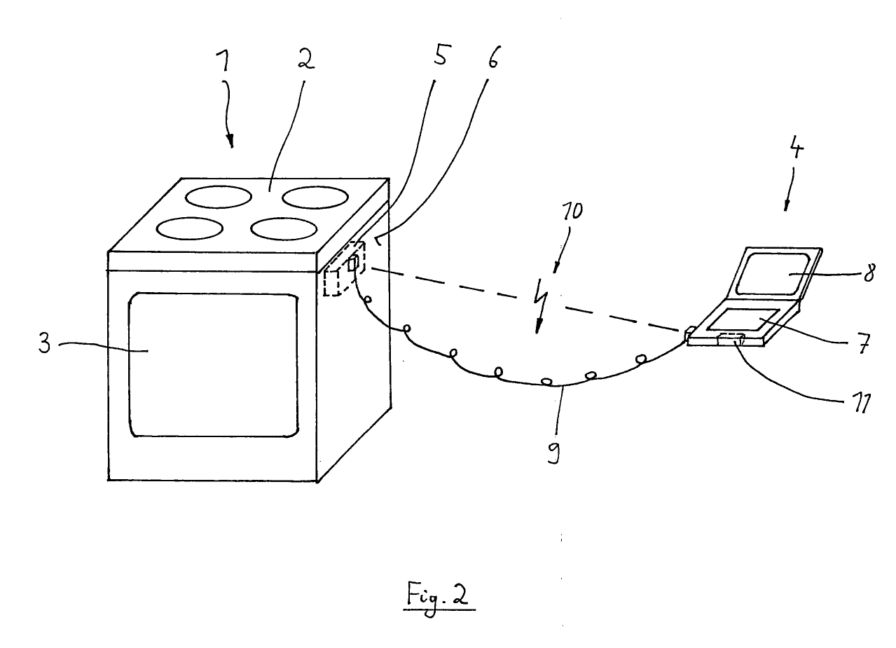

FIG. 2 shows the same view of the cooking appliance, but during use of the user interface and the cooking appliance.

FIG. 1 shows a cooking appliance 1, which could be an oven, particularly a domestic oven, which is equipped in a usual manner with a hob 2 with four hotplates 12. Furthermore, it has a cooking cavity 3. The controlling of the cooking appliance 1 is done W by a user interface 4. In FIG. 1 the user interface 4 is located at a side of the frame 6 of the cooking appliance. For this a not depicted holder can be employed. Also a magnetic connection can be used.

The user interface 4 is detachably connected with the cooking appliance 1. I. e. the user interface 4 can be taken and be removed from the cooking appliance itself.

The data connection between the user interface 4 and the cooking appliance 1 itself can be done via a wire 9 or wireless. In FIG. 1 the user interface 4 is connected via a wire 9 with a control system 5 which controls the elements of the hob 2 and the cooking cavity 3. Alternatively, there can be two control systems, one for the hob 2 and one for the cooking cavity 3. In this case, the user interface 4 is connected via wires or in a wireless manner with the control system which controls the elements of the hob 2 and with the control system which controls the cooking cavity 3.

In FIG. 1 the cooking appliance is shown during non-use. FIG. 2 shows the whole system during use.

The user interface 4 is taken away from the cooking appliance 1. For the purpose of illustration two possibilities are depicted how the data connection can be established between the user interface 4 and the cooking appliance 1, especially the control system 5: A wire 9 can be used for the connection (as explained above) and—alternatively—a wireless connection which is schematically numbered with 10.

In the shown embodiment the user interface 4 is a more or less usual laptop with an inputting device 7 in the form of a keyboard and a displaying device 8 in the form of a screen. Also a usual memory device 11 is arranged.

With the user interface 4 the whole system can be controlled. There is a bidirectional communication between the user interface 4 and the cooking appliance 1, i. e. data can be transferred from the cooking appliance 1 to the user interface 4 to be displayed on the screen 8 and data can as well be transferred after inputting via the inputting device 7 to the cooking appliance 1 to control the cooking process taking place there.

Due to the possibility to store data it is possible that the recipe related data are stored in the memory device 12. So a search function can be used to search for recipe data in the memory. The best setting for a specific recipe can thus be searched and selected. The search and selection of data can be an interactive process, e. g. data of the dish to be prepared can be inputted (kind of meat, weight of the dish to be prepared) and a search can be carried out to find the best data for cooking. By clicking a respective pushbutton of the keyboard 7 the data can be transferred to the cooking appliance 1 and the cooking process can be started. All important cooking parameters can be displayed permanently on the screen 8 (e. g. temperatures and running times).

Also an electronic cookbook can be stored in the memory device 11, from which data can retrieved during preparation of the cooking process.

As the user interface 4 is not a fixed part of the cooking appliance 1 but can be taken away from it, there is no need for the respective space within the cooking appliance for the interface. Consequently, the space can be fully used for the hob 2 and the cooking cavity 3.

Beneficially, a direct setting and visibility of settings can be realized. Due to the relatively big display (screen) it is possible to display simultaneously a direct feedback about each zone of the cooking appliance and if it is active as well as about the duration of the cooking process. The status of each zone of the cooking appliance can thus be displayed directly. This includes e. g. the temperatures of the cooking zones, pauses and activation of child safety modes. That means the cooking appliance 1 is controlled via a terminal.

The database with the recipes allows the selection of optimal cooking parameters.

is The different options can be displayed simultaneously on the screen.

Also, it is possible to give a direct feedback when the cooking process is carried out. This can be supported by using different colours on the display.

Reference Numerals

1 Cooking appliance

2 Hob

3 Cooking cavity

4 User interface

5 Control system

6 Part (frame)

7 Inputting device

8 Displaying device

9 Wire

10 Wireless connection

11 Memory device

12 hotplate

Patent claims:

1. Cooking appliance with a hob (2) and/or a cooking cavity (3) and an user interface (4) for inputting and/or displaying information for controlling a cooking process in the cooking appliance (1),
characterized in that the user interface (4) is an external or independent unit with respect to the cooking appliance (1) or arranged outside of the cooking appliance (1) and/or that the user interface is detachably arranged or fastened at the cooking appliance.

2. Cooking appliance according to claim 1, characterized in that it further has at least one control system (5) for controlling the cooking process in the cooking appliance (1).

3. Cooking appliance according to claim 2, characterized in that the at least one control system (5) is firmly connected with the hob (2) and/or the cooking cavity (3) or a part (6), especially a frame, carrying the same.

4. Cooking appliance according to at least one of claims 1 to 3, characterized in that the user interface (4) is constructed as a unit having at least on inputting device (7) and at least one displaying device (8).

5. Cooking appliance according to at least one of claims 1 to 4, characterized in that the user interface (4) is in data connection with the cooking appliance (1), especially with the at least one control system (5), by means of a wire connection (9).

6. Cooking appliance according to at least one of claims 1 to 4, characterized in that the user interface (4) is in data connection with the cooking appliance (1), especially with the at least one control system (5), in a wireless manner (10).

7. Cooking appliance according to claim 6, characterized in that the wireless connection (10) is a radio connection.

8. Cooking appliance according to claim 6, characterized in that the wireless connection (10) is a blue-tooth connection.

9. Cooking appliance according to at least one of claims 4 to 8, characterized in that the inputting device (7) is a keyboard or keypad.

10. Cooking appliance according to at least one of claims 4 to 9, characterized in that the displaying device (8) is a screen.

11. Cooking appliance according to claim 10, characterized in that the screen (8) is a touch-screen.

12. Cooking appliance according to at least one of claims 1 to 11, characterized in that the user interface (4) has a memory device (11) for recording data for controlling a cooking process in the Cooking appliance (1).

13. Cooking appliance according to claim 12, characterized in that the memory device (11) is arranged for receiving cooking recipe data for a plurality of recipes.

14. Cooking appliance according to claim 13, characterized in that the cooking receipe data include related cooking parameters.

15. Cooking appliance according to at least one of claims 12 to 14, characterized in that the memory device (11) is arranged for receiving data of an electronic handbook.

16. Cooking appliance according to at least one of claims 1 to 15, characterized in that the user interface (4) is a laptop.
